(19) United States
(12) Patent Application Publication
(10) Pub. No.: US 2025/0376873 A1
(43) Pub. Date: Dec. 11, 2025

(54) CONVENIENT ESCAPE LOCK WITH INDICATING FUNCTION

(71) Applicant: Huiyi LI, Guangdong (CN)

(72) Inventor: Zhilian WANG, Guangdong (CN)

(21) Appl. No.: 19/216,717

(22) Filed: May 23, 2025

(30) Foreign Application Priority Data
Jun. 5, 2024 (CN) 202421351073.0

(51) Int. Cl. E05B 13/10; E05B 41/00

(52) U.S. Cl. CPC E05B 13/105; E05B 41/00

(57) ABSTRACT

A convenient escape lock, including a wafer lock core, a rear handle, and a lock tongue. The wafer lock core is nested into and connected with a lock core sleeve, which in turn is nested into and connected with a first washer; the wafer lock core and the lock core sleeve are nested and installed inside a front handle body, which is connected to a front handle core, which is equipped with a second washer; the front handle core penetrates a front cover and is fixed with a front rotating frame. The front cover has a status indicator plate to indicate lock or unlocked state of the escape lock. Emergency escape is achieved by pressing or lifting the rear handle. A disabled person can lock the door by simply pressing the knob assembly. The texts of the status indicators of the status indicator plate can effectively prevent accidental unlocking.

### TECHNICAL FILED

The present invention relates to the technical field of escape locks, specifically to a convenient escape lock with an indicating function.

### BACKGROUND OF THE INVENTION

With societal development and advancements in building modernization, designs of door locks increasingly prioritize anti-theft performance. This has led to complex internal structures of door locks. In emergencies such as earthquakes or fires, users may struggle to find keys to quickly unlock the doors, hindering timely escape. Additionally, the lack of an indicating device on the door locks makes it difficult to confirm whether the door locks are properly latched or unlatched. To address these issues, a conveniently operable escape lock structure is designed to better meet practical usage requirements.

### BRIEF SUMMARY OF THE INVENTION

In view of the aforesaid disadvantages in the prior art, it is an object of the present invention to provide a convenient escape lock with indicating function.

To achieve the above object, the present invention provides the following technical solutions: A convenient escape lock with an indicating function, comprising a wafer lock core, a rear handle, and a lock tongue; the wafer lock core is nested into and connected with a lock core sleeve, which in turn is nested into and connect with a first washer; the wafer lock core and the lock core sleeve are nested and installed inside a front handle body; the front handle body is connected to a front handle core, which is equipped with a second washer; the front handle core penetrates through a front cover and is fixed with a front rotating frame; the front cover is equipped with a status indicator plate to indicate a lock or an unlocked state of the escape lock, and the front cover is fixed to a front baffle via at least one first screw; a square body is symmetrically fixed on the lock tongue; the square body is nested into a first clutch component; the first clutch component is penetrated by a safety rod; the front handle core is connected to the front baffle via a torsion spring; the front baffle is connected to at least one front post via at least one set screw respectively; a knob assembly is nested into and connect with the rear handle; the knob assembly is sleeved by a button sleeve; the button sleeve is connected to a rear rotating frame via a snap ring, and the rear handle is also nested into and connected with the button sleeve; the rear handle and a rear baffle are interconnected; the rear baffle is fixed to said at least one front post via at least one cross countersunk screw respectively; the rear baffle is fixed with a fixing plate via at least one second screw; the fixing plate is connected to the rear rotating frame via another torsion spring; the rear baffle is fixed with a lock-from-inside clutch fixing plate via at least one third screw; at least one lock-from-inside clutch body is disposed between the lock-from-inside clutch fixing plate and the rear baffle.

Preferably, side protrusions of the wafer lock core are engaged with slots on the front handle core; the front handle core penetrates through the front cover and the status indicator plate to engage with the front handle body. Due to these preferable structures, the present invention is ensured to operate normally.

Preferably, the status indicator plate is located between the front cover and the front baffle, and is engaged with the safety rod; the status indicator plate is marked with status indicators to show locked and unlocked states of the escape lock. Due to the status indicator plate, the locked and unlocked states of the door can be clearly indicated to facilitate user to observe.

Preferably, the first clutch component is symmetrically equipped with safety balls, which are nested in the slots of the front handle core. Due to the safety balls, a basic function of secured locking of the escape lock is guaranteed.

Preferably, one end of a square body spring is fixed to the first clutch component, and another end of the square body spring is fixed inside the square body. Due to the resilience of the square body spring, normal operation of the escape lock can be guaranteed.

Preferably, each of said at least one lock-from-inside clutch body is slidably connected to the lock-from-inside clutch fixing plate and engaged with the rear baffle; each of said at least one lock-from-inside clutch body is provided with a respective lock-from-inside clutch pressure spring disposed between a corresponding lock-from-inside clutch body and the rear baffle. Due to the use of said at least one lock-from-inside clutch body and a respective lock-from-inside clutch pressure spring, a basic function of locking from inside of the escape lock is guaranteed.

Preferably, the knob assembly is connected to the safety rod; outer protrusions of the knob assembly are slidably connected to arc-shaped slots of the button sleeve respectively. Due to the knob assembly, a basic action force for locking from inside of the escape lock can be provided.

Preferably, one end of a safety button pressure spring is fixed to the knob assembly, and another end of the safety button pressure spring is fixed to the square body. Due to the safety button pressure spring, a basic action force for resetting the knob assembly is provided.

Compared with the prior arts, the present invention has the following beneficial effects: The present invention uses a newly developed button-type (left or right opening) universal installation structure. By pressing or lifting the rear handle, a door can be quickly opened for emergency escape. For disabled persons, the door is locked by simply pressing the knob assembly. The texts of the status indicators of the status indicator plate can effectively prevent accidental unlocking, thereby enhancing the convenience of using the escape lock.

### BRIEF DESCRIPTION OF THE DRAWINGS

FIG. 1 is an exploded perspective view of the overall composition of the escape lock according to the present invention;

FIG. 2 is a perspective view of the overall composition of the escape lock;

FIG. 3 is a top view of the overall composition of the escape lock;

FIG. 4 is a top cross-sectional view of the overall composition of the escape lock;

FIG. 5 is an exploded view of a wafer lock core and a front handle core according to the preset invention;

FIG. 6 is an exploded view of a button sleeve and a knob assembly according to the present invention.

In the drawings:
1. Wafer lock core; 101. Side protrusion of the wafer lock core; 2. Lock core sleeve; 3. First washer; 4. Front handle body; 5. Front handle core; 501. slot on the front handle core; 6. Second washer; 7. Front cover; 8. Status indicator plate; 9. Safety ball; 10. First clutch component; 11. Square body spring; 12. Safety rod; 13. Front baffle; 14. Torsion spring; 15. Set screw; 16. First screw; 17. Front rotating frame; 18. Front post; 19. Snap ring; 20. Square body; 21. Rear rotating frame; 22. Button sleeve; 2201. arc-shaped slot 2201 of the button sleeve; 23. Second screw; 24. Third screw; 25. Fixing plate; 26. Lock-from-inside clutch fixing plate; 27. Lock-from-inside clutch pressure spring; 28. Lock-from-inside clutch body; 29. Rear baffle; 30. Cross countersunk screw; 31. Safety button pressure spring; 32. Knob assembly; 3201. Outer protrusion of the knob assembly; 33. Rear handle; 34. Lock tongue.

### DETAILED DESCRIPTION OF THE INVENTION

The following describes the technical solutions of the present invention clearly and thoroughly with reference to the accompanying drawings. The described embodiments are only some but not all of the embodiments of the present invention. Based on the embodiments of the present invention, all other embodiments obtainable by ordinary technicians in the field of art without any inventive efforts shall also fall within the protection scope of the present invention.

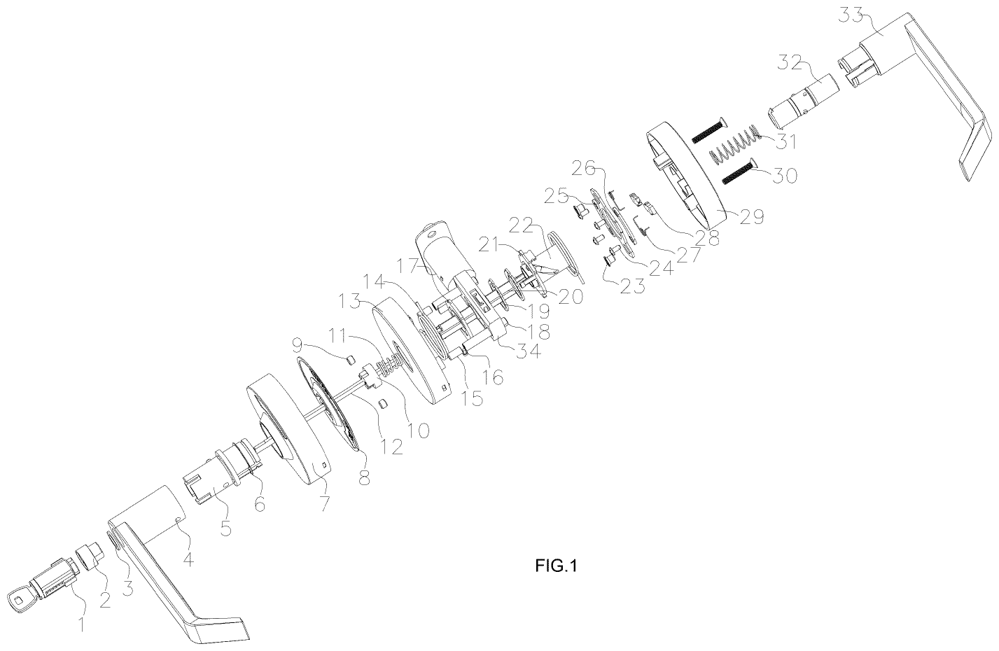

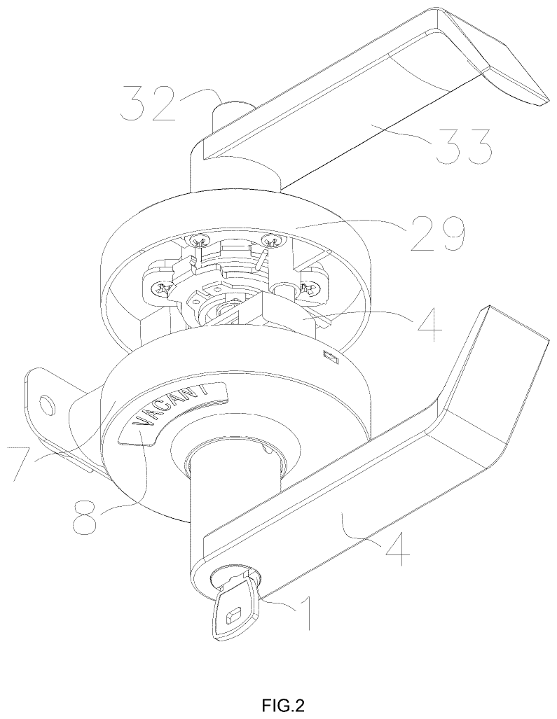

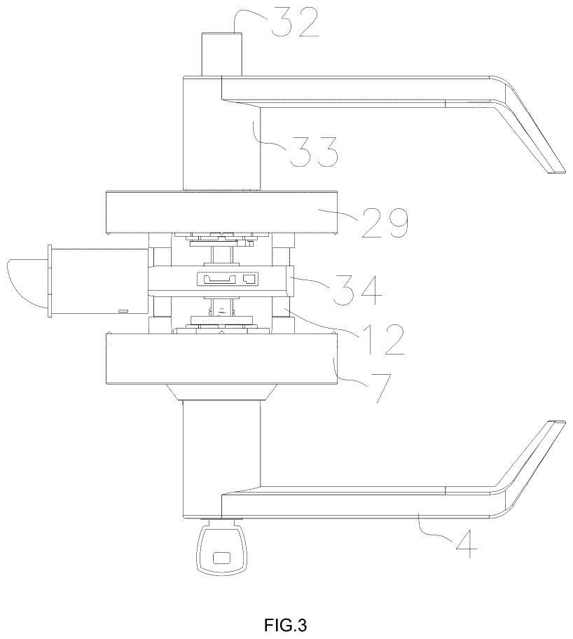

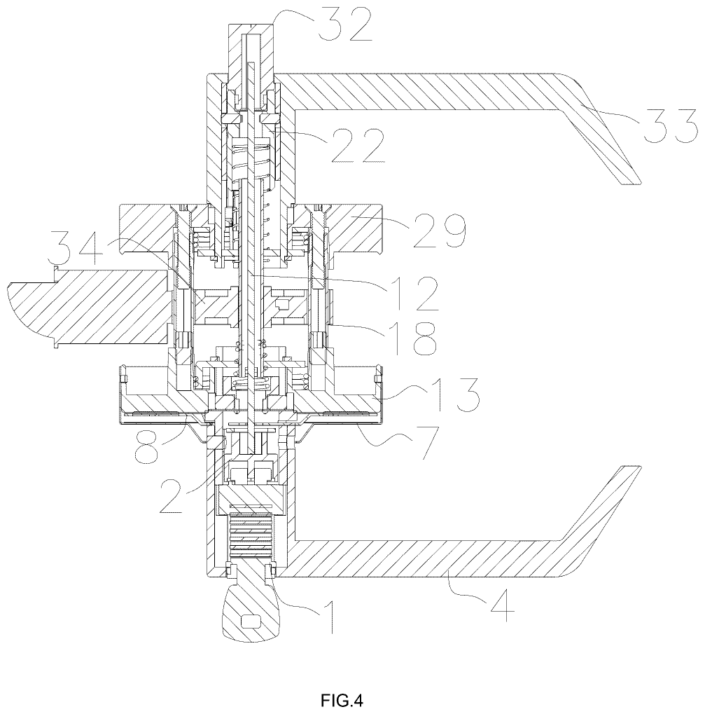

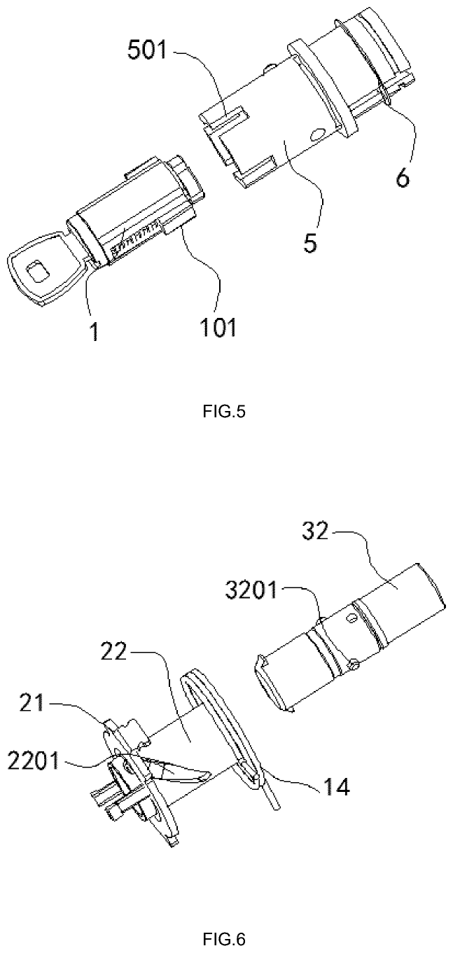

Referring to FIGS. 1-6, the present invention provides the following technical solutions: A convenient escape lock with an indicating function, comprising a wafer lock core 1, a rear handle 33, and a lock tongue 34; the wafer lock core 1 is nested into and connected with a lock core sleeve 2, which in turn is nested with a first washer 3; the wafer lock core 1 and the lock core sleeve 2 are nested and installed inside a front handle body 4; the front handle body 4 is connected to a front handle core 5, which is equipped with a second washer 6; the front handle core 5 penetrates through a front cover 7 and is fixed with a front rotating frame 17; the front cover 7 is equipped with a status indicator plate 8 to indicate a lock or an unlocked state of the escape lock, and the front cover 7 is fixed to a front baffle 13 via at least one first screw 16; a square body 20 is symmetrically fixed on the lock tongue 34; the square body 20 is nested into a first clutch component 10; the first clutch component 10 is penetrated by a safety rod 12; the front handle core 5 is connected to the front baffle 13 via a torsion spring 14; the front baffle 13 is connected to at least one front post 18 via at least one set screw 15 respectively; a knob assembly 32 is nested into and connect with the rear handle 33; the knob assembly 32 is sleeved by a button sleeve 22; the button sleeve 22 is connected to a rear rotating frame 21 via a snap ring 19, and the rear handle 33 is also nested into and connected with the button sleeve 22; the rear handle 33 and a rear baffle 29 are interconnected; the rear baffle 29 is fixed to said at least one front post 18 via at least one cross countersunk screw 30 respectively; the rear baffle 29 is fixed with a fixing plate 25 via at least one second screw 23; the fixing plate 25 is connected to the rear rotating frame 21 via another torsion spring 14; the rear baffle 29 is fixed with an lock-from-inside clutch fixing plate 26 via at least one third screw 24; at least one lock-from-inside clutch body 28 is disposed between the lock-from-inside clutch fixing plate 26 and the rear baffle 29.

Side protrusions 101 of the wafer lock core 1 are engaged with slots 501 on the front handle core 5; the front handle core 5 penetrates through the front cover 7 and the status indicator plate 8 to engage with the front handle body 4; the status indicator plate 8 is located between the front cover 7 and the front baffle 13, and is engaged with the safety rod 12; the status indicator plate 8 is marked with status indicators to show locked and unlocked states of the escape lock; the first clutch component 10 is symmetrically equipped with safety balls 9, which are nested in the slots of the front handle core 5; one end of a square body spring 11 is fixed to the first clutch component 10, and another end of the square body spring 11 is fixed inside the square body 20.

As shown in FIGS. 1-6, a front handle assembly is defined by the wafer lock core 1, the lock core sleeve 2, the first washer 3, the front handle body 4, and the front handle core 5. A front baffle assembly is defined by the second washer 6, the front cover 7, the status indicator plate 8, the safety balls 9, the first clutch component 10, the square body spring 11, the safety rod 12, the front baffle 13, the torsion spring 14, said at least one set screw 15, said at least one first screw 16, the front rotating frame 17, said at least one front post 18, the snap ring 19, and the square body 20. In practical use, rotate the wafer lock core 1 counterclockwise by 90 degrees to rotate the status indicator plate 8 to the left via the lock core sleeve 2, the safety rod 12, and the first clutch component 10, thus pushing out the safety balls 9 into slots of the front baffle 13 to lock the front handle body 4 from rotation with respect to the front baffle 13, and hence forming a locked state through the status indicator plate 8. Since the status indicator plate 8 is rotated to the left, specific color and text are displayed by the status indicator plate 8 through a fan-shaped window of the front cover 7 to indicate the locked state. By rotating the wafer lock core 1 clockwise by 90 degrees, the status indicator plate 8 is rotated to the right via the lock core sleeve 2, the safety rod 12, and the first clutch component 10, thus withdrawing the safety balls 9 into the front handle core 5, allowing the front handle body 4 to rotate freely with respect to the front baffle 13 by 45 degrees, and thence an unlocked state is achieved.

Each of said at least one lock-from-inside clutch body 28 is slidably connected to the lock-from-inside clutch fixing plate 26 and engaged with the rear baffle 29; each of said at least one lock-from-inside clutch body 28 is provided with a respective lock-from-inside clutch pressure spring 27 disposed between a corresponding lock-from-inside clutch body 28 and the rear baffle; the knob assembly 32 is connected to the safety rod 12; outer protrusions 3201 of the knob assembly 32 are slidably connected to arc-shaped slots 2201 of the button sleeve 22; one end of a safety button pressure spring 31 is fixed to the knob assembly 32, and another end of the safety button pressure spring 31 is fixed to the square body 20.

As shown in FIGS. 1-6, a rear baffle assembly is defined by the rear rotating frame 21, the button sleeve 22, said at least one second screw 23, said at least one third screw 24, the fixing plate 25, the lock-from-inside clutch fixing plate 26, the lock-from-inside clutch pressure spring 27, the lock-from-inside clutch body 28, the rear baffle 29, said at least one cross countersunk screw 30, the safety button pressure spring 31, the knob assembly 32, and the rear handle 33. The rear baffle assembly is formed by installing the lock-from-inside clutch body 28, the lock-from-inside clutch pressure spring 27, and the lock-from-inside clutch fixing plate 26 on the rear baffle 29 via said at least one third screw 24, and then installing the rear handle assembly on the rear baffle 29 via said at least one second screw 23 and the fixing plate 25. The rear baffle assembly features a newly developed button-type (left or right opening) universal installation structure. By pressing or lifting the rear handle 33, door can be quickly opened for emergency escape. For disabled persons, the door is locked by simply pressing the knob assembly 32, and the escape lock and thus the door is unlocked by simply lifting or pressing the rear handle 33 by 45 degrees, thereby enabling quick escape.

The newly developed rear quick-opening/closing mechanism works as follows: Upon pressing the knob assembly 32, sliding action achievable by outer protrusions 3201 of the knob assembly 32 in the arc-shaped slots 2201 of the button sleeve 22 causes the knob assembly 32 to rotate by 90 degrees, and then the knob assembly 32 slides down to a position such that the lock-from-inside clutch body 28 locks the knob assembly 32 in place, thus achieving a closing action. By means of the button sleeve 22, the safety rod 12 is driven leading to driven movements of the first clutch component 10 and the safety balls 9, the locked state is achieved. For quick opening or escape, simply lift or press the rear handle 33 by 45 degrees. A slot of the rear handle 33 pushes the lock-from-inside clutch body 28, separating the knob assembly 32 and the safety button pressure spring 31, thereby pushing the knob assembly 32 upward, and by rotating of the button sleeve 22 by 90 degrees driving the safety rod 12, the first clutch component 10, and the safety balls 9, the unlocked state is achieved.

In summary, the convenient escape lock with indicating function is installed as follows: The front handle body 4 and the front baffle assembly are installed on an outer side of a door. Similarly, the rear handle 33 and the rear baffle assembly are installed on an inner side of the door. The lock tongue 34 is connected in the middle between the front baffle assembly and the rear baffle assembly, the front baffle assembly and the rear baffle assembly, with the lock tongue 34 in the middle, in combination with interconnecting structures comprising the square body 20, the front post 18, and said at least one set screw 15, are connected via said at least one cross countersunk screw 30. The front cover 7 and the rear baffle 29 are of the same size, ensuring a sturdy and stable structure with diverse surface treatments. The square body 20 connects to the rear rotating frame 21 through the lock tongue 34, thus enhancing sturdiness and durability during use. The front handle body 4 and the front rotating frame 17, as well as the rear handle 33 and the rear rotating frame 21, are paired to operate. The front rotating frame 17 and the rear rotating frame 21 are made of 1.5 mm cold-rolled steel and formed by a single time shaping process, and they are later carburized for enhanced pressure resistance, thus ensuring long-term durability. The wafer lock core 1 can be set for timed or unrestricted use. The fan-shaped window on the front cover 7 and the specific texts/colors displayed by the status indicator plate 8 provide clear visibility. The fan-shaped window is located at an upper portion of the front cover 7, thus minimizing accidental openings. The escape lock of the present invention can be installed on left-or right-opening doors, offering universal installation. The working principle of the convenient escape lock with an indicating function according to the present invention is described as above.

Although the embodiments of the present invention have been shown and described, ordinary technicians in the field can make various changes, modifications, substitutions, and variations without departing from the principles and spirit of the present invention. The scope of the present invention is defined by the appended claims and their equivalents.

What is claimed is:

1. An escape lock with an indicating function, comprising a wafer lock core, a rear handle, and a lock tongue; wherein the wafer lock core is nested into and connected with a lock core sleeve, which in turn is nested into and connected with a first washer; the wafer lock core and the lock core sleeve are nested and installed inside a front handle body; the front handle body is connected to a front handle core, which is equipped with a second washer; the front handle core penetrates through a front cover and is fixed with a front rotating frame; the front cover is equipped with a status indicator plate to indicate a lock or an unlocked state of the escape lock, and the front cover is fixed to a front baffle via at least one first screw; a square body is symmetrically fixed on the lock tongue; the square body is nested into a first clutch component; the first clutch component is penetrated by a safety rod; the front handle core is connected to the front baffle via a torsion spring; the front baffle is connected to at least one front post via at least one set screw respectively; a knob assembly is nested into and connect with the rear handle; the knob assembly is sleeved by a button sleeve; the button sleeve is connected to a rear rotating frame via a snap ring, and the rear handle is also nested into and connected with the button sleeve; the rear handle and a rear baffle are interconnected; the rear baffle is fixed to said at least one front post via at least one cross countersunk screw respectively; the rear baffle is fixed with a fixing plate via at least one second screw; the fixing plate is connected to the rear rotating frame via another torsion spring; the rear baffle is fixed with a lock-from-inside clutch fixing plate via at least one third screw; at least one lock-from-inside clutch body is disposed between the lock-from-inside clutch fixing plate and the rear baffle.

2. The escape lock of claim 1, wherein side protrusions of the wafer lock core are engaged with slots on the front handle core; the front handle core penetrates through the front cover and the status indicator plate to engage with the front handle body.

3. The escape lock of claim 1, wherein the status indicator plate is located between the front cover and the front baffle, and is engaged with the safety rod; the status indicator plate is marked with status indicators to show locked and unlocked states of the escape lock.

4. The escape lock of claim 1, wherein the first clutch component is symmetrically equipped with safety balls, which are nested in the slots of the front handle core.

5. The escape lock of claim 1, wherein one end of a square body spring is fixed to the first clutch component, and another end of the square body spring is fixed inside the square body.

6. The escape lock of claim 1, wherein each of said at least one lock-from-inside clutch body is slidably connected to the lock-from-inside clutch fixing plate and engaged with the rear baffle; each of said at least one lock-from-inside clutch body is provided with a respective lock-from-inside clutch pressure spring disposed between a corresponding lock-from-inside clutch body and the rear baffle.

7. The escape lock of claim 1, wherein the knob assembly is connected to the safety rod; outer protrusions of the knob assembly are slidably connected to arc-shaped slots of the button sleeve respectively.

8. The escape lock of claim 1, wherein one end of a safety button pressure spring is fixed to the knob assembly, and another end of the safety button pressure spring is fixed to the square body.
